(19) United States
(12) Patent Application Publication
(10) Pub. No.: US 2008/0106092 A1
(43) Pub. Date: May 8, 2008

(54) MANIFOLD ARRANGEMENT

(75) Inventors: Donald J. Klein, Jackson, TN (US); Samuel P. Adams, Jackson, TN (US)

Correspondence Address: CALFEE HALTER & GRISWOLD, LLP, 800 SUPERIOR AVENUE, SUITE 1400, CLEVELAND, OH, 44114, US

(73) Assignee: LASCO FITTINGS, INC., Brownsville, TN (US)

(21) Appl. No.: 11/934,221

(22) Filed: Nov. 2, 2007

Related U.S. Application Data
(60) Provisional application No. 60/856,625, filed on Nov. 3, 2006.

(51) Int. Cl. B05B 15/00

(52) U.S. Cl. 285/5

(57) ABSTRACT

A fluid coupling that attaches to a threaded component. The body portion of the fluid coupling has an end that defines a flow path along an axis and includes a first seal groove. An extension of the fluid coupling is mounted onto the end. The extension rotates about the axis and moves axially relative to the body portion. The extension includes a threaded tip for threadably coupling the threaded component. The extension also has a radially extending face adjacent the tip that includes a second seal groove. A first seal of the fluid coupling is positioned in the first seal groove and is adapted to provide a seal between the body portion and the extension. A second seal of the fluid coupling is positioned in the second seal groove and is adapted to provide a seal between the extension and the threaded component.

### CROSS REFERENCE TO RELATED APPLICATIONS

This application claims the benefit of U.S. provisional patent application Ser. No. 60/856,625, filed Nov. 3, 2006, entitled “Manifold Arrangement” which is incorporated herein by reference in its entirety.

### BACKGROUND

Irrigation sprinkler systems are used on farms, golf courses, residential yards, and other places to provide water to crops, lawns, gardens or other plants. Many commercial and residential irrigation systems are “in ground” systems, which means that most of the components of the system, such as pipes, sprinklers, and irrigation valves, are buried or below ground. These systems typically include one or more below ground valve boxes that house one or more manifold arrangements. The manifold arrangements often include multiple solenoid valves, arranged in parallel, for routing water to various sections of the sprinkler system. A male adapter or nipple is typically used to attach rigid piping to a female threaded port on each solenoid valve. Due to high water pressure, hard plumbing is used. Because the sprinkler system is rigid and in a below ground valve box, installation and repair can be cumbersome due to alignment and pipe length requirements and limited access.

### SUMMARY

The present application discloses exemplary fluid couplings for fluidly connecting various components of fluid systems together. The fluid coupling may be a telescoping, or adjustable, fluid coupling. An exemplary implementation comprises a manifold arrangement for an irrigation sprinkler system. In particular, the application discloses a manifold arrangement that includes an adjustable fluid coupling of the present invention for fluidly connecting a component such as a valve, or conduit to the system.

In accordance with one exemplary embodiment, the manifold arrangement includes at least one system component attached to a fluid conduit by a fluid coupling. The fluid coupling may include an extension mounted to a body portion. The extension may be rotatable and axially movable relative to the body portion.

In accordance with another exemplary embodiment, the manifold arrangement may include a valve having a female threaded port and a fluid coupling for connecting the valve to a fluid conduit. The fluid coupling may include a male threaded tip for threadably engaging the female threaded port and a face seal for engaging a surface on valve to create a seal between the valve and the coupling. The fluid coupling may be adapted to allow hand-tightening of the coupling to the valve.

Further aspects and concepts will become apparent to those skilled in the art after considering the following description and appended claims in conjunction with the accompanying drawings.

### BRIEF DESCRIPTION OF THE DRAWINGS

In the accompanying drawings, which are incorporated in and constitute a part of the specification, embodiments of the invention are illustrated, which, together with a general description of the invention given above, and the detailed description given below, serve to exemplify embodiments of the invention:

FIG. 1 is a schematic view of an exemplary embodiment of an irrigation fluid system comprising an exemplary manifold arrangement;

FIG. 2 is a perspective view of a portion of the exemplary manifold arrangement of FIG. 1, including a plurality of exemplary couplings according to the invention;

FIG. 3 is a partial cross-sectional view of an embodiment of a fluid coupling for the exemplary arrangement of FIG. 1 with the adjustable portions in a first position;

FIG. 4 is a partial cross-sectional view of an embodiment of a fluid coupling for the exemplary arrangement of FIG. 1 with the adjustable portions in a second position;

FIG. 5A is a partial cross-sectional view of an embodiment of a fluid coupling for the exemplary arrangement of FIG. 1 with an adjustable portion in a second position and not pivoted;

FIG. 5B is a partial cross-sectional view of an embodiment of a fluid coupling for the exemplary arrangement of FIG. 1 with an adjustable portion in a second position and pivoted;

FIG. 6 is a partial cross-sectional view of a second embodiment of a fluid coupling for the exemplary arrangement of FIG. 1;

FIG. 7 is a partial cross-sectional view of a third embodiment of a fluid coupling for the exemplary arrangement of FIG. 1;

FIG. 8 is a partial cross-sectional view of a fourth embodiment of a fluid coupling for the exemplary arrangement of FIG. 1;

FIG. 9 is a partial cross-sectional view of a fifth embodiment of a fluid coupling for the exemplary arrangement of FIG. 1;

FIG. 10 is a partial cross-sectional view of a sixth embodiment of a fluid coupling for the exemplary arrangement of FIG. 1;

FIG. 11 is a partial cross-sectional view of a seventh embodiment of a fluid coupling for the exemplary arrangement of FIG. 1;

FIG. 12 is a partial cross-sectional view of an eighth embodiment of a fluid coupling for the exemplary arrangement of FIG. 1;

FIG. 13 is a partial cross-sectional view of a ninth embodiment of a fluid coupling for the exemplary arrangement of FIG. 1; and

FIG. 14 is a partial cross-sectional view of a tenth embodiment of a fluid coupling for the exemplary arrangement of FIG. 1.

### DETAILED DESCRIPTION

The present application discloses exemplary fluid couplings, exemplary manifold arrangements, and exemplary irrigation sprinkler systems. While the exemplary embodiments illustrated and described herein are presented in the context of an extendable tubular fluid coupling threadably attached to one or more solenoid valves for a residential irrigation sprinkler system, those skilled in the art will readily appreciate that the present invention may be used and configured in other ways. For example, the exemplary fluid couplings and manifold systems may be used in any application where an extendable fluid coupling would be beneficial. This may include residential irrigation, commercial irrigation, or some other non-irrigation or non-sprinkler system application. In addition, the fluid coupling may attach to the solenoid in any manner suitable to provide leak-free fluid communication. Furthermore, the fluid coupling may attach to a system component or conduit other than a solenoid valve, such as another coupling having two female threaded ports. Still further, the fluid coupling need not necessarily be tubular, but may be configured in any manner suitable for providing fluid communication with a valve or other system component. Still further, the fluid coupling may have an extension pivotable relative to the body portion of the coupling with undersized threads such that the coupling is compatible with many types of valves, may be tightened by hand, and overcomes any misalignment of the port of the solenoid valve relative to the coupling.

While various aspects and concepts of the invention are described and illustrated herein as embodied in combination in the exemplary embodiments, these various aspects and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or identified herein as conventional or standard or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

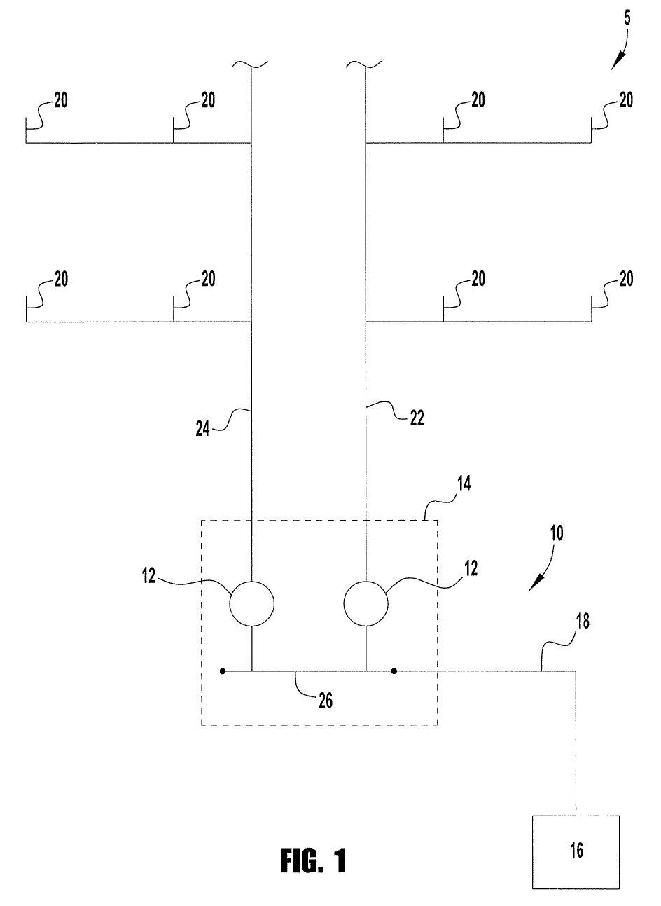

Referring now to the figures, FIG. 1 schematically illustrates an exemplary fluid system 5 comprising an exemplary manifold arrangement 10 that may include one or more valves 12 arranged within a valve box 14. The valves 12 may be, for example, 24 volt, 1 inch female national pipe threads (NPT) inlet and outlet, electronically actuated solenoid valves (e.g., Toro brand in-line valves sold as model no. 53708), which are often used in residential irrigation sprinkler systems. The valves 12 may be fluidly connected, in parallel, to a fluid source 16 by a fluid line or conduit 18. Each valve 12, may also be fluidly connected to one or more downstream system components 20, such as for example, sprinklers, by additional fluid conduits 22, 24, respectively. The valves 12, may be connected to each of the aforementioned fluid conduits 18, 22, 24 by one or more fluid couplings 26, such that when a valve is opened, fluid may flow from the fluid source 16 through the valve 12 and to the downstream component. The fluid coupling 26 may include one or more extendable or telescoping portions.

Those skilled in the art will readily appreciate that the manifold arrangement 10 and/or fluid coupling 26 may be used and configured in a variety of ways. For example, the couplings may be used with a valve, a conduit, or some other system component. In addition, virtually any number of valves or components, arranged in parallel or series, may be employed. Further, the fluid coupling 26 may be configured in a variety of ways, such as for example, as a Tee, an elbow, a cross, or other configuration. The fluid coupling 26 may also connect to the other component(s) or conduit(s) in a variety of ways. For example, the coupling may have one or more nipple ends, male or female threaded ends, slip-on connector ends or any other suitable connector.

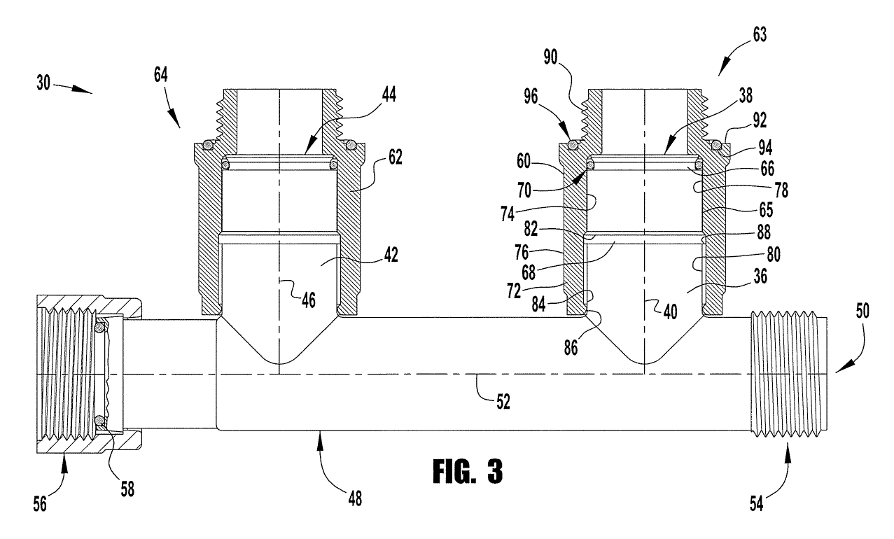

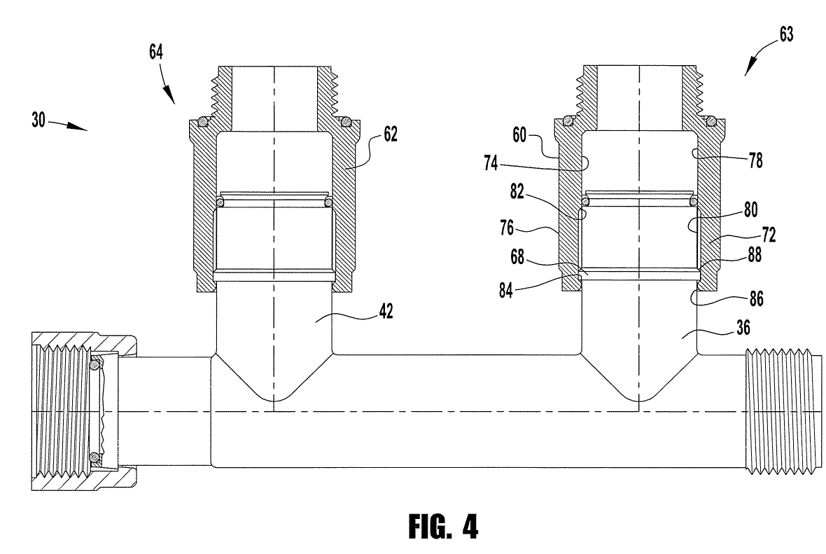

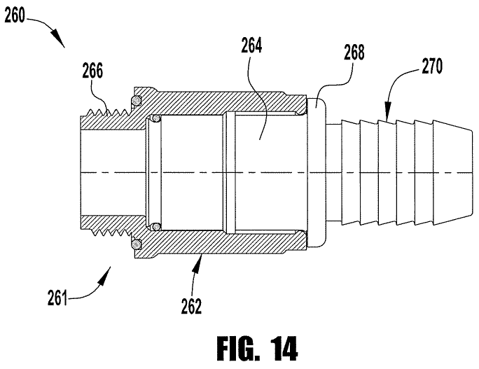

FIGS. 4-14 illustrate some exemplary coupling embodiments, but should not be construed as limiting other possible configurations. The fluid coupling may include a body portion having a first end that defines a flow path. An extension may mount onto the first end such that the extension may be rotatable and axially movable relative to the body portion. The extension may include a male threaded tip for engaging and connecting to a system component, such as a valve, though other ways of attaching to the component are possible. For example, a second coupling having at least two female threaded ports may be used to connect the extension to a component having a male threaded port. Sealing elements may also be provided for sealing between the extension and the component and the extension and the body portion.

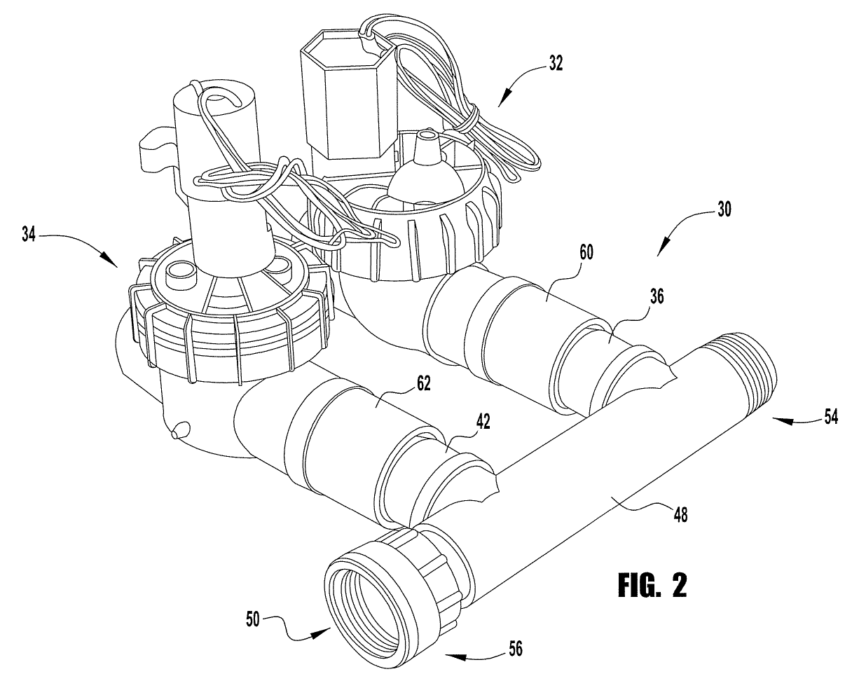

Referring to FIGS. 2 and 3, an exemplary fluid coupling 30 is illustrated attached to a first solenoid valve 32 and a second solenoid valve 34. The fluid coupling 30 may include a first tubular portion 36 defining a first flow passage 38 having a first axis 40 and a second tubular portion 42 defining a second flow passage 44 having a second axis 46. The first and second tubular portions 36, 42 may connect to a third tubular portion 48 that defines a third flow passage 50 having a third axis 52. Although the tubular portions are shown as being cylindrical in the figures, the tubular portions may have virtually any cross section, such as oval, square, rectangular, triangular, random, symmetrical, non-symmetrical, etc.

In the depicted embodiment, the first tubular portion 36 and the second tubular portion 42 connect substantially perpendicular to the third tubular portion 48 and substantially parallel to each other. The third tubular portion 48 may have one or more ends 54, 56 that are adapted to couple to another system component or conduit. For example, in the depicted embodiment, the third tubular portion 48 is tubular and includes a male threaded end 54 and a female threaded end 56. A sealing arrangement or element 58, such as a gasket or O-ring, may be provided on both or either end to provide a seal with a system component or conduit.

A first tubular extension 60 may be movably positioned on the first tubular portion 36 and a second tubular extension 62 may be movably positioned on the second tubular portion 42. Thus, the first tubular extension 60/first tubular portion 36 forms a first adjustable portion 63 of the fluid coupling 30 and the second tubular extension 62/second tubular portion 42 forms a second adjustable portion 64. The first adjustable portion 63 and the second adjustable portion 64 may be substantially similar; thus, only the first adjustable portion 63 will be discussed in detail, with the understanding that the disclosure applies equally to the second adjustable portion 64. In the depicted embodiment, the first tubular extension 60 is telescoping received over the first tubular portion 36 such that the extension may slide axially along the first tubular portion between a first or retracted position and a second or extended position, discussed in detail hereinafter.

The first tubular portion 36 may have a generally cylindrical outer surface 65. The outer surface 65 may include an annular seal groove 66 and a stop surface 68, such as for example, an annular ridge. A sealing element 70, such as for example an o-ring, may be positioned within the seal groove 66 for providing a seal between the first tubular extension 60 and the first tubular portion 36.

The first tubular extension 60 may have a first wall portion or side wall 72 having a generally cylindrical configuration centered on the first axis 40. The side wall 72 may have generally parallel, cylindrical inner and outer side surfaces 74, 76. The inner side wall surface 74 defines a bore or passage 78 that is sized slightly larger than the outer diameter of the first tubular portion 36. The inner side wall surface 74 may include an annular recess 80 extending along a length of the inner surface. The annular recess 80 may be connected to the inner side surface 74 by first and second opposing radial shoulders 82, 84.

The first tubular extension 60 may include an end 86 with a tapered surface and the stop 68 may include an opposite facing tapered surface 88. The tapered surfaces 86, 88 may cooperate to allow the first tubular extension 60 to be initially snapped or pressed onto the first tubular portion 36. An exemplary method of assembling the fluid coupling includes the steps of: inserting the sealing element 70 within the seal groove 66; aligning the first tubular extension 60 with the first tubular portion 36; and applying slight pressure to the first tubular extension, with for example an arbor press or hydraulic press, such that the first tubular extension snaps onto the first tubular portion. Further, a lubricant, such as silicon or grease, may be used to assist in the assembly of the fluid coupling. Once positioned on the first tubular portion 36, the first tubular extension 60 may not be readily removed and can retain a mating configuration with the first tubular portion 36 at high pressures, such as for example at least about 500 psi.

The first tubular extension 60 may be positioned on the first tubular portion 36 such that the extension is rotatable relative to the portion, both clockwise and counter-clockwise for assembly and disassembly with the system component or valve. In addition, the first tubular extension 60 may be axially movable relative to the first tubular portion 36 between a first or retracted position or a second or extended position. FIG. 3 illustrates the first adjustable portion 63 and the second adjustable portion 64 in the first or fully retracted position and FIG. 4 illustrates the first adjustable portion 63 and the second adjustable portion 64 in the second or fully extended position.

The stop 68 on the first tubular portion 36 extends radially outward from the first tubular portion into the recess 80 of the first tubular extension 60. Thus, axial movement of the first tubular extension 60 is limited by engagement of the stop 68 with the radial shoulder 82 at the first position (FIG. 3) and with radial shoulder 84 at the second position (FIG. 4). The first and second adjustable portions 63, 64; thus, may be positioned in a fully extended position, a fully retracted position, or any position in between in order to couple to a component or conduit.

The first tubular extension 60 may also have some side-to-side movement, or wobble, when positioned on the first tubular portion 36. The side-to-side movement may allow the tubular extension to attach, or mate, to a system component or conduit whose alignment is offset from the axis 40 while still maintaining a seal between the extension and the first tubular portion 36. The side-to-side movement also protects against cross threading.

As shown in FIG. 5a, an axis 49 of the first tubular extension 60 is generally coaxial with the axis 40 of the first tubular portion 36. The first tubular extension 60, however, may move relative to the first tubular portion 36 such that the axis 49 of the first tubular extension is no longer coaxial with the axis 40 of the first tubular portion. The axis 49 of the first tubular extension 60 may diverge from the axis 40 of the first tubular portion 36. The axis 49 of the first tubular extension 60 may even remain parallel to, but not coaxial with, the axis 40 of the first tubular portion 36.

For example, as shown in FIG. 5b, the sealing element 70 acts as a pivot point allowing the first tubular extension 60 to pivot slightly relative to the first tubular portion 36 such that axes 49, 40 are no longer coaxial. The pivoted first tubular extension 60 forms a narrow opening 41 between the first tubular portion 36 and the first tubular extension. The amount of pivot and size of the opening 41 will vary depending on such factors as, for example, the roundness of the first tubular portion 36 and the position of the telescoping first tubular extension 60 relative to the first tubular portion. For example, in certain embodiments, when the first tubular extension 60 is about 0.5 cm from full extension, relative to the first tubular portion 36, the axis 49 of the first tubular extension may pivot approximately 1 to 2 degrees relative to the axis 40 of the first tubular portion. Further, the sealing element 70 maintains a seal between the first tubular extension 60 and the first tubular portion 36 with the first tubular extension pivoted so that the axes 49, 40 are no longer coaxial.

The first tubular extension 60 typically includes a threaded tip 90 having male threads; however, in certain embodiments (not shown), the threaded tip has female threads. Further, the threaded tip 90 generally has tapered national pipe threads (NPT); however, in certain embodiments, other suitable thread types known in the art may work, such as for example national straight pipe threads (NPS).

The tip 90 may be adapted to threadably engage a fluid system component or conduit, such as for example one of the valves 32 illustrated in FIG. 2. In one exemplary embodiment, the tip 90 may be specifically adapted to threadably engage the female threaded port of a 24 volt, 1 inch, electronically actuated solenoid valve, which is often used in residential irrigation sprinkler systems. The female threads on the solenoid valve are typically tapered pipe threads, or NPT threads, but may have other suitable thread types known in the art, such as straight pipe threads, or NPS threads.

NPT is a standard for tapered threads that are used to join pipe and fittings. NPT threaded pipes and fittings can provide an effective seal for transporting liquids, gases, steam, and hydraulic fluid. The taper on NPT threads allows them to form a seal when torqued as the flanks of the threads compress against each other, as opposed to straight thread fittings or compression fittings in which the threads merely hold the pieces together and do not provide the seal. Since the threads compress against each other, a wrench or other torquing device must be used to make the sealing connection.

In the exemplary embodiment of the coupling of FIGS. 2-3, the male threaded tip 90 has NPT threads. However, the NPT threads on the male threaded tip 90 are undersized NPT threads. For example, as shown, the male NPT threads of the threaded tip 90 are undersized approximately 1 turn small from nominal. The diameter of the male threads on the undersized NPT threaded tip 90 is smaller than the diameter of nominal NPT threads on a male threaded component sized to threadably mate with a nominal NPT threaded female component.

The undersized male NPT threads on the male threaded tip 90 prevent the flanks of the threads from compressing against each other to form a seal. Further, the undersized male NPT threads allow the male threaded tip 90 to be hand-tightened into a standard NPT female threaded component, without the use of a wrench or other torquing device. In order to provide a seal between the coupling 30 and the valve 32, the first tubular extension 60 may include a radial extending surface 92 adjacent the male threaded tip 90. The radially extending surface 92 may include a seal groove 94 and the seal element 96, such as for example a gasket or an o-ring, positioned within the seal groove 94. When the first tubular extension 60 is threaded into the valve 32, the radial extending surface 92 engages a corresponding surface on the valve 32 such that the seal element 96 forms a face seal therebetween. Thus, the single seal element may effectively provide a seal between the component and the extension 60, even when hand-tightened. For example, a user may thread the tubular extension 60 into the valve 32 by hand, compressing the seal element 96 and creating a watertight seal capable of withstanding at least 20 psi of water pressure.

The coupling 30 may be formed from a variety of materials. In one embodiment, the coupling is molded from a suitable plastic, such as polyvinyl chloride (PVC), and requires no post fabrication, such as for example post fabrication machining, to function after assembly. As a moldable coupling, the seal grooves 66, 94 may be seamless molded grooves, which require no machining to be formed.

Thus, the coupling 30 may fluidly connect the valves 32, 34 to one or more system components or conduits. Because the tubular extensions 60, 62 are both axially movable and rotatable, connections with fixed piping or valves does not required specific lengths of pipes to cut or other adapters to be installed. Further, the tubular extension 60, 62 allow the coupling 30 to be compatible with most valves.

Those skilled in the art will readily appreciate that the manifold arrangement 10 may be configured in a variety of ways. For example, the fluid coupling 30 may be formed as a tee, an elbow, a cross, or other configuration; may have one or more nipple ends, threaded ends, slip fit ends; or other connection; and may include one or multiple extensions. FIGS. 4-14 illustrate some exemplary embodiments, but should not be construed as limiting other possible configurations.

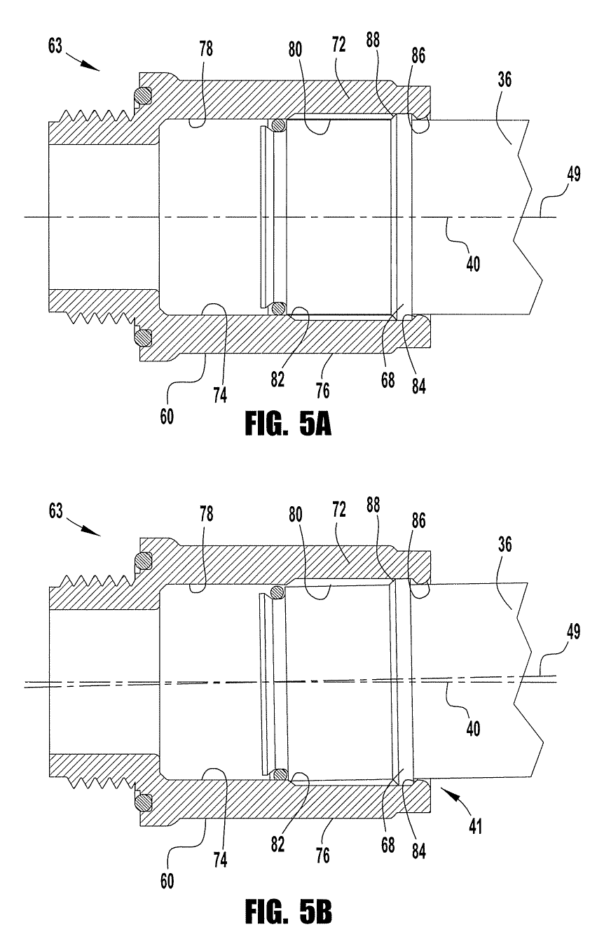

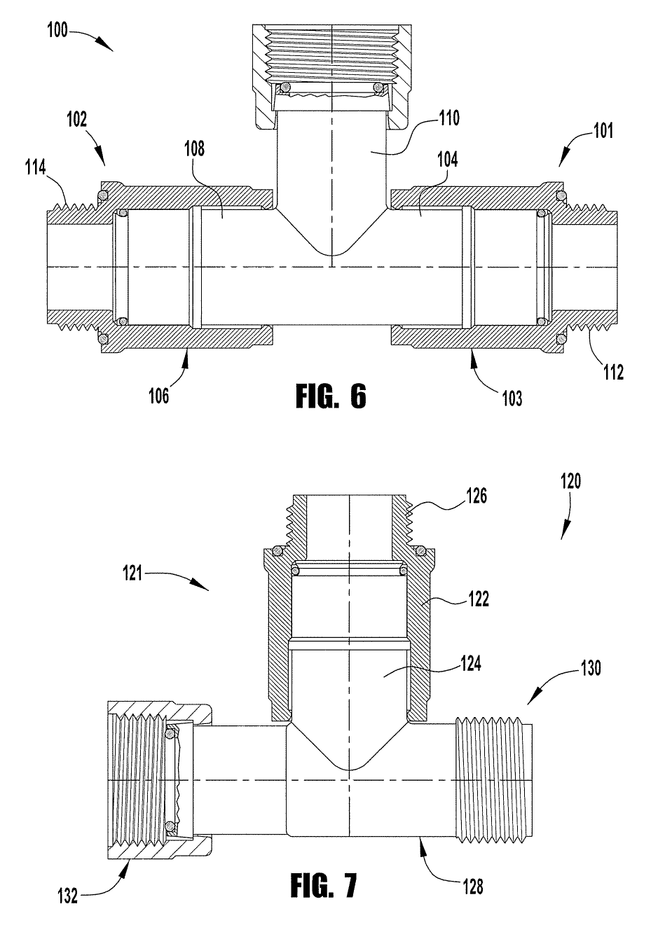

In FIG. 6, an exemplary embodiment of a coupling 100 is presented. The coupling 100 includes a first adjustable portion 101 and a second adjustable portion 102 that may be the same as the first adjustable portion 63 and the second adjustable portion 64 of the coupling 30 of FIG. 3 in that it includes a first tubular extension 103 positioned on a first tubular portion 104 and a second tubular extension 106 positioned on a second tubular portion 108. Both the first tubular portion 104 and the second tubular portion 108 being in fluid communication with a third tubular portion 110. In addition, both the first tubular extension 102 and the second tubular extension 106 may be rotatable and axially movable relative to the first tubular portion 102 and second tubular portion 108, respectively. Furthermore, the first tubular extension 102 and second tubular extension 106 may include a male threaded tip 112, 114 adapted to threadably engage a female threaded port of a component, such as an electronic solenoid valve.

The coupling 100, however, is arranged in a T-configuration, such that the first adjustable portion 101 and the second adjustable portion 102 extend generally coaxially, in opposite directions, from each other while the third tubular portion 110 extends generally perpendicular to the first and second adjustable portions.

In FIG. 7, another exemplary embodiment of a coupling 120 is presented The coupling 120 includes a first adjustable portion 121 that may be the same as the first adjustable portion 101 of the coupling 100 of FIG. 4 in that it includes a first tubular extension positioned on a first tubular portion 124. The first tubular extension 122 being rotatable and axially movable relative to the first tubular portion 124 and including a male threaded tip 126 adapted to threadably engage a female threaded port of a component, such as an electronic solenoid valve. The coupling 120 also include a second tubular portion 128 having a male threaded end 130 and a female threaded end 132, similar to the third tubular portion 30 of FIG. 3. The coupling 120, however, includes only a single adjustable portion 121 whereas the coupling 100 of FIG. 4 includes two or more adjustable portions 101, 102.

In FIG. 8, another exemplary embodiment of a coupling 140 is presented. The coupling 140 may include an adjustable portion 141 that may be the same as the first adjustable portion 121 of the coupling 120 of FIG. 7 in that it includes a first tubular extension 142 positioned on a first tubular portion 144. The first tubular extension 142 being rotatable and axially movable relative to the first tubular portion 144 and including a male threaded tip 146 adapted to threadably engage a female threaded port of a component, such as an electronic solenoid valve. The coupling 140 may also include a second tubular portion 148. The coupling 140, however, instead of including a female threaded end, includes a slip on connector 150 for receiving and sliding over the end of a pipe or adapter.

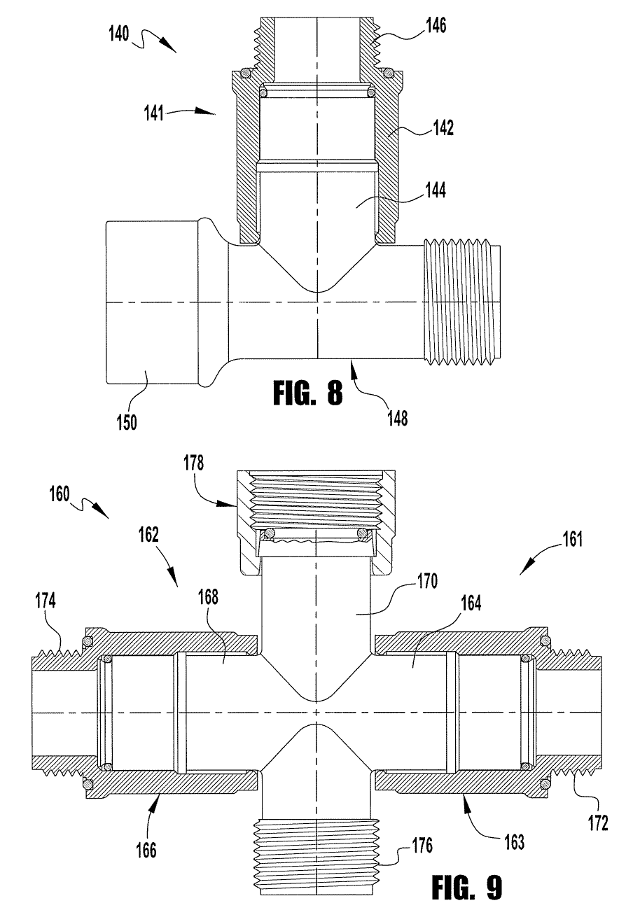

In FIG. 9, another exemplary embodiment of a coupling 160 is presented. The coupling 160 may include a first adjustable portion 161 and a second adjustable portion 162 that may be the same as the first and second adjustable portions 101 and 102 of the coupling 100 of FIG. 6 in that it includes a first tubular extension 163 positioned on a first tubular portion 164 and a second tubular extension 166 positioned on a second tubular portion 168. Both the first tubular portion 164 and the second tubular portion 168 being in fluid communication with a third tubular portion 170. In addition, both the first tubular extension 163 and the second tubular extension 166 may be rotatable and axially movable relative to the first tubular portion 164 and second tubular portion 168, respectively. Furthermore, the first tubular extension 163 and second tubular extension 166 may include male threaded tips 172, 174 adapted to threadably engage a female threaded port of a component, such as an electronic solenoid valve. Furthermore, first tubular portion 164 and the second tubular portion 168 may extend generally coaxially, in opposite directions, while the third tubular portion 170 extends generally perpendicular to the first and second portions.

The coupling 160, however, is arranged in a cross configuration, such that the third tubular portion 170 includes a male threaded end 176 and a female threaded end 178 that may extend generally coaxially, in opposite directions of each other.

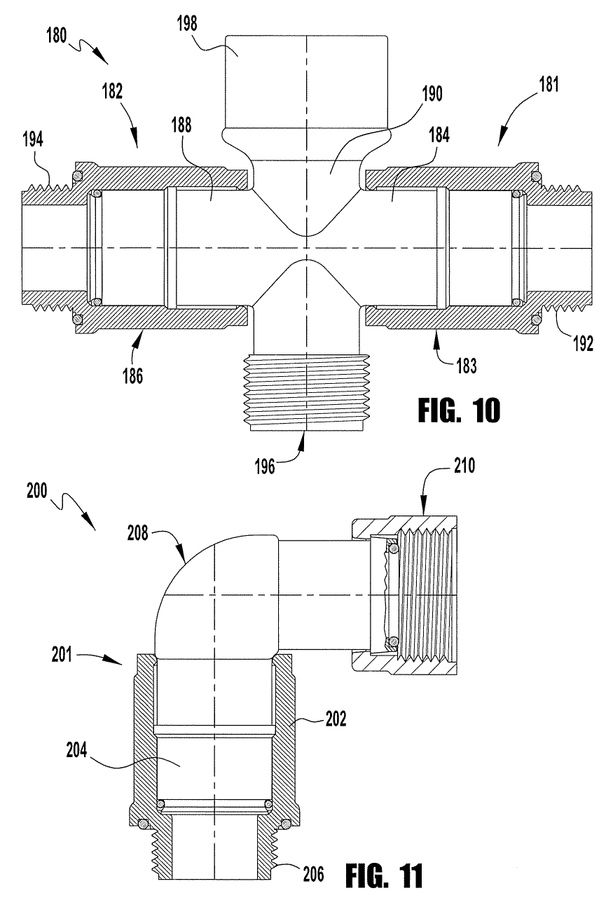

In FIG. 10, another exemplary embodiment of a coupling 180 is presented. The coupling 180 may include a first adjustable portion 181 and a second adjustable portion 182 that may be the same as the first adjustable portion 161 and a second adjustable portion 162 to the coupling 160 of FIG. 9 in that it includes a first tubular extension 183 positioned on a first tubular portion 184 and a second tubular extension 186 positioned on a second tubular portion 188. Both the first tubular portion 184 and the second tubular portion 188 being in fluid communication with a third tubular portion 190. In addition, both the first tubular extension 183 and the second tubular extension 186 being rotatable and axially movable relative to the first tubular portion 184 and second tubular portion 188, respectively. Furthermore, the first tubular extension 183 and second tubular extension 186 may include male threaded tips 192, 194 adapted to threadably engage a female threaded port of a component, such as an electronic solenoid valve. Furthermore, the first tubular portion 184 and the second tubular portion 188 may extend generally coaxially, in opposite directions, while the third tubular portion 190 extends generally perpendicular to the first and second tubular portions. The coupling 180, however, includes a male threaded end 196 and a slip over connection end 198 that may extend generally coaxially, in opposite directions of each other.

In FIG. 11, another exemplary embodiment of a coupling 200 is presented. The coupling 200 may include a first adjustable portion 201 that may be the same as the first adjustable portion 121 of the coupling 120 of FIG. 7 in that it includes a first tubular extension 202 positioned on a first tubular portion 204. The first tubular extension 202 being rotatable and axially movable relative to the first tubular portion 204 and including a male threaded tip 206 adapted to threadably engage a female threaded port of a component, such as an electronic solenoid valve. The coupling 200 may also including a second tubular portion 208 having a female threaded end 210. The coupling 200, however, is arranged in a 90 degree elbow configuration, though any angle of the elbow is possible, such as sixty degrees, forty-five degrees, or any other angle.

In FIG. 12, another exemplary embodiment of a coupling 220 is presented. The coupling 220 may include a first adjustable portion 221 that may be the same as the first adjustable portion 201 of the coupling 200 of FIG. 10 in that it includes a first tubular extension 222 positioned on a first tubular portion 224. The first tubular extension 222 being rotatable and axially movable relative to the first tubular portion 224 and including a male threaded tip 226 adapted to threadably engage a female threaded port of a component, such as an electronic solenoid valve. The first tubular portion 224 may be fluid communication with a second tubular portion 228 and the coupling 220 being arranged in elbow configuration. The second tubular portion 228 of the coupling 220, however, includes a male threaded end 230, rather than a female threaded end as depicted with coupling 200 of FIG. 11.

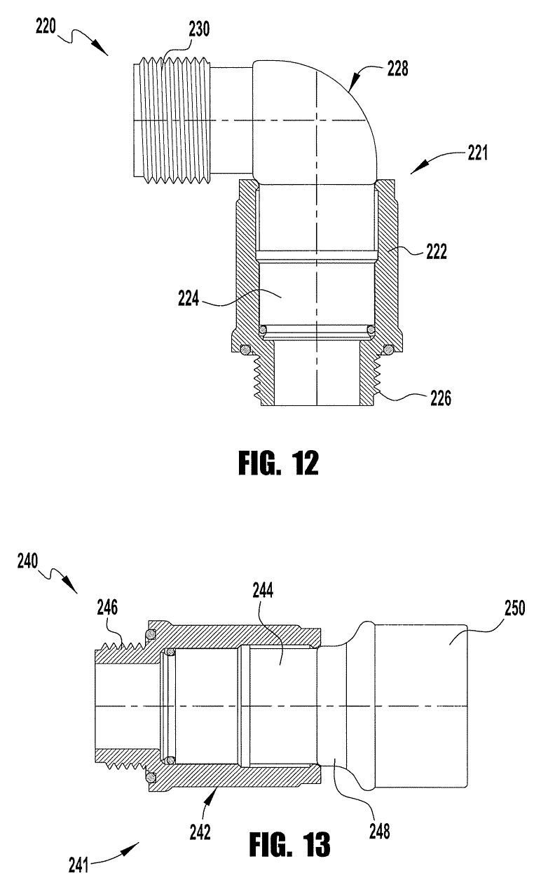

In FIG. 13, another exemplary embodiment of a coupling 240 is presented. The coupling 240 may include a first adjustable portion 241 that may be the same as the first adjustable portion 221 of the coupling 220 of FIG. 11 in that it includes a first tubular extension 242 positioned on a first tubular portion 244. The first tubular extension 242 being rotatable and axially movable relative to the first tubular portion 244 and including a male threaded tip 246 adapted to threadably engage a female threaded port of a component, such as an electronic solenoid valve. The first tubular portion 244 being in fluid communication with a second tubular portion 248 The second tubular portion 248 of the coupling 240, however, extends substantially coaxially with the first tubular portion 244 and includes a slip-on connection end 250.

In FIG. 12, another exemplary embodiment of a coupling 260 is presented. The coupling 260 may include a first adjustable portion 261 that may be the same to the first adjustable portion 241 of the coupling 240 of FIG. 13 in that it includes a first tubular extension 262 positioned on a first tubular portion 264. The first tubular extension 262 being rotatable and axially movable relative to the first tubular portion 264 and including a male threaded tip 266 adapted to threadably engage a female threaded port of a component, such as an electronic solenoid valve. The first tubular portion 264 being in fluid communication with a second tubular portion 268 that extends substantially coaxially with the first tubular portion. The coupling 260, however, may include a serrated nipple end 270 for insertion into a pipe or other port. The nipple end 270, may be configured suitably (diameter and length) for the pipe or port to which it engages.

The invention has been described with reference to the preferred embodiments. Modification and alterations will occur to others upon a reading and understanding of this specification. For example, any of the various fluid couplings, manifolds, and methods herein may be practiced with a female tip (not shown) on the telescoping portion for coupling to a male coupling. It is intended to include all such modifications and alterations insofar as they come within the scope of the appended claims or the equivalents thereof.

1. A fluid coupling for attaching to a first threaded component, comprising:
a body portion having a first end that defines a flow path along a first axis, the first end including a first seal groove;
an extension mounted onto the first end; the extension being rotatable about the first axis and movable axially relative to the body portion; the extension including a threaded tip for threadably coupling the first threaded component and a radially extending face adjacent the tip; the radially extending face including a second seal groove;
a first seal positioned in the first seal groove adapted to provide a seal between the body portion and the extension; and
a second seal positioned in the second seal groove adapted to provide a seal between the extension and the first threaded component.

2. The fluid coupling of claim 1 further comprising a raised stop on an outer surface of the first end and an inward extending ridge on an inner surface of the extension; the raised stop and the ridge cooperating to limit axial movement of the extension relative to the body portion.

3. The fluid coupling of claim 2 wherein the raised stop and ridge cooperate to retain the extension on the first end.

4. The fluid coupling of claim 1, wherein the first threaded component comprises a female threaded component and the threaded tip comprises undersized male threads such that the diameter of the male threads on the threaded tip is smaller than the diameter of nominal male threads on a male threaded component sized to threadably mate with nominal female threads on the female threaded component.

5. The fluid coupling of claim 4, wherein the threaded tip can be threaded into the female threaded component and sufficiently tightened by hand such that the second seal provides a seal between the extension and the female threaded component.

6. The fluid coupling of claim 1, wherein the extension has a second axis and the first seal acts as a pivot point allowing the extension to pivot slightly relative to the first end so that the second axis is no longer coaxial with the first axis.

7. The fluid coupling of claim 6, wherein the first seal maintains a seal between the body portion and the extension with the extension pivoted so that the first axis and the second axis are no longer coaxial.

8. The fluid coupling of claim 1, wherein the fluid coupling is assembled by aligning the extension with the first end and applying sufficient pressure such that the extension snaps onto the first end.

9. The fluid coupling of claim 8, wherein the extension is not readily removable and can retain a mating configuration with the first end at high pressures.

10. The fluid coupling of claim 9, wherein the extension retains the mating configuration with the first end at a pressure of at least 500 psi.

11. The fluid coupling of claim 1, wherein the extension is hand-rotatable about the first axis both clockwise and counter-clockwise for assembly and disassembly with the first threaded component.

12. The fluid coupling of claim 1, wherein the fluid coupling is molded from plastic and requires no post fabrication machining to function after assembly.

13. The fluid coupling of claim 12, wherein the plastic is polyvinyl chloride (PVC).

14. The fluid coupling of claim 1, wherein the first seal groove and second seal groove are seamless molded grooves.

15. The fluid coupling of claim 1, wherein the first threaded component is a coupling having at least two female threaded components.

16. The fluid coupling of claim 1, wherein the first threaded component is a solenoid valve having a female threaded port.

17. A manifold arrangement for a sprinkler system, comprising:
at least one solenoid valve including a female threaded port; and
a fluid coupling for attaching to the solenoid valve, comprising:
a body portion having a tubular first end that defines a flow path along a first axis, the tubular first end including a first seal groove;
a tubular extension mounted onto the tubular first end; the tubular extension being rotatable about the first axis and movable axially relative to the body portion; the tubular extension including a male threaded tip for threadably engaging the female threaded port of the at least one solenoid valve and a radially extending face adjacent the tip, the radially extending face including a seal groove;
a first seal positioned in the first seal groove for sealing between the body portion and the tubular extension; and
a second seal positioned in the second seal groove for sealing between the tubular extension and the female threaded port of the at least one solenoid valve.

18. The manifold arrangement of claim 17, wherein the fluid coupling further comprises a raised stop on an outer surface of the tubular first end and an inward extending ridge on an inner surface of the tubular extension, the raised stop and the ridge cooperating to limit axial movement of the extension relative to the body portion.

19. The manifold arrangement of claim 17, wherein the male threads on the male threaded tip are undersized such that the diameter of the male threads on the male threaded tip is smaller than the diameter of nominal male threads on a male threaded component sized to threadably mate with nominal female threads of the female threaded port.

20. The manifold arrangement of claim 17, wherein the male threaded tip can be threaded into the female threaded port and sufficiently tightened by hand such that the second seal provides a seal between the tubular extension and the female threaded port.

21. The manifold arrangement of claim 17, wherein the tubular extension has a second axis and the first seal acts as a pivot point allowing the tubular extension to pivot slightly relative to the tubular first end so that the second axis is no longer coaxial with the first axis.

22. The manifold arrangement of claim 21, wherein the first seal maintains a seal between the body portion and the tubular extension with the tubular extension pivoted so that the first axis and the second axis are no longer coaxial.

23. A method of installing a manifold arrangement for a sprinkler system; the method comprising the steps of:
providing a fluid coupling having a first end that defines a flow path along a first axis, a second end, and an extension having a male threaded tip mounted on the first end, the extension being rotatable about the first axis, pivotable relative to the first end, and extendable relative to the first end;
providing at least one sprinkler system component having a female threaded port;
attaching the second end of the fluid coupling to a pressurized water source;
extending the extension of the fluid coupling axially toward the female threaded port of the at least one sprinkler system component;
pivoting the extension relative to the first end to overcome misalignment of the female threaded port of the at least one sprinkler system component relative to the first axis; and
threadably mating the male threads on the male threaded tip and the female threads on the female threaded port of the at least one sprinkler system component.

24. A fluid coupling for attaching to a female threaded sprinkler system component, comprising:
a body portion having a first end that defines a flow path along a first axis, the first end including a first seal groove;
an extension mounted onto the first end; the extension being rotatable about the first axis and movable axially relative to the body portion; the extension including a male threaded tip and a radially extending face adjacent the tip; the radially extending face including a second seal groove;
a first seal positioned in the first seal groove adapted to provide a seal between the body portion and the extension;
a second seal positioned in the second seal groove adapted to provide a seal between the extension and the female threaded sprinkler system component;
a raised stop on an outer surface of the first end and an inward extending ridge on an inner surface of the extension; the raised stop and the ridge cooperating to limit axial movement of the extension relative to the body portion;
wherein the male threads on the male threaded tip are undersized such that the diameter of the male threads on the male threaded tip is smaller than the diameter of nominal male threads on a male threaded component sized to threadably mate with nominal female threads on the female threaded sprinkler system component;
wherein the male threaded tip can be threaded into the female threaded sprinkler system component and sufficiently tightened by hand such that the second seal provides a seal between the extension and the female threaded sprinkler system component;
wherein the extension has a second axis and the first seal acts as a pivot point allowing the extension to pivot slightly relative to the first end so that the second axis is no longer coaxial with the first axis;
wherein the first seal maintains a seal between the body portion and the extension with the extension pivoted so that the first axis and the second axis are no longer coaxial; and
wherein the fluid coupling is assembled by aligning the extension with the first end and applying sufficient pressure such that the extension snaps onto the first end.

25. A fluid coupling for attaching to a female threaded component, comprising:
a male threaded tip;
a radially extending face adjacent the male threaded tip, the radially extending face including a seal groove;
a seal positioned in the seal groove adapted to provide a seal between the radially extending face and the female threaded component; and
wherein the male threads of the male threaded tip are undersized such that the diameter of the male threads on the male threaded tip is smaller than the diameter of nominal male threads on a male threaded component sized to threadably mate with nominal female threads on the female threaded component.
